(19) United States
(12) Patent Application Publication
(10) Pub. No.: US 2002/0019778 A1
(43) Pub. Date: Feb. 14, 2002

(54) System and method for placing on-line orders

(76) Inventors: Larry Isaacson, Brooklyn, NY (US); Matthew Isaacson, Brooklyn, NY (US)

Correspondence Address: Brown Raysman Millstein Felder & Steiner LLP, 900 Third Avenue, New York, NY, 10022, US

(21) Appl. No.: 09/826,298

(22) Filed: Apr. 4, 2001

Related U.S. Application Data
(60) Provisional application No. 60/194,632, filed on Apr. 4, 2000.

(51) Int. Cl. G06F 17/60

(52) U.S. Cl. 705/26; 705/28; 709/217

(57) ABSTRACT

A system and method permitting the placement of orders and the accumulation of free product credits, wherein a user can select from a vendor's most commonly ordered products; recreate and/or edit past orders to expedite the placement of similar orders; transfer a large number of selected purchases to the final purchase order or to a shopping cart in a single action; accumulate free product credits throughout successive transactions; and redeem the credits for products selected from the vendor's merchandise.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention generally relates to a method and system for electronically ordering products.

### BACKGROUND

Electronic ordering systems such as the client-server based ordering systems commonly encountered over the World Wide Web can be somewhat cumbersome to use. In a typical ordering system, the user has to first perform a search for the product to be ordered. The search can be in the form of a drill-down search, where a user picks a category, reviews subcategories within that category, picks the relevant subcategory, reviews the products in that subcategory, and finally picks the desired product. Alternatively, if the user remembers how the desired product is referred to in the ordering system's database, the user may perform a direct search, typing-in the name of the desired product and waiting for the search engine to identify the appropriate entry in the ordering system's database.

In either case, a user's first step in utilizing an ordering program is conducting a search. This can be a nuisance. Even if the user remembers how a given product is named or referred to by the ordering system, the user must still wait while the system searches for the product. Only after the search is completed can the user fill in the desired quantity and place the order. In certain circumstances it may be more desirable to have a more simplified ordering method and system which bypasses the preliminary step of searching for goods or services yet still enables the user to find the products he or she needs most of the time. In addition, it is desirable to minimize the number of actions that the user must execute from the stage of selecting products to completing a purchase order therefor.

Product ordering systems may also be coupled with award systems that issue “points” to consumers or collectors in order build or enhance their loyalty to the merchant. Such points are typically redeemed for money, air miles or merchandise that is different from the type of merchandise the purchase of which earned the user the award points in the first place. Sometimes, this is not what users, or more especially their organizations, actually desire, in which case the loyalty award system will not be particularly effective.

### SUMMARY OF INVENTION

The invention provides an electronic ordering method and system that, in some circumstances, can eliminate the need to conduct a comprehensive preliminary product search. Generally speaking, this is accomplished by presenting the user with one or more lists of the most commonly purchased products in pre-defined product categories. Preferably, the list of most commonly purchased products, as well as the category names and types, are customizable to each customer's or select customers' preferences.

According to another aspect of the invention, each aforementioned categorized product list is displayable on a requisition order form that has an input field or box for enabling the user to enter desired quantities. The system captures the desired quantities onto an aggregate product list such as a virtual shopping cart or purchase order without requiring the user to select an “accept” button or the like each time a categorized product list is displayed. Also, each time a user changes the entered quantity by deleting it or changing it to zero (0), the system automatically deletes the selected product for which the quantity was so changed.

According to another aspect of the invention, the system provides a user with access to prior purchase orders. The user may select previously ordered products for inclusion in a new or current order.

According to another aspect of the invention, the system allows the user to accumulate free product credits with each order placed to a vendor. The free product credits do not need to be redeemed at the time the order is placed and are redeemable for merchandise sold by the vendor.

The method and system of the present invention may be implemented over a global computer network such as, for example, the Internet, or over a CD-ROM, and can be applied to place orders for goods or services in any field of commerce. The “user” contemplated by the system can be an individual or a company, preferably a company.

In one embodiment, a user can view products that are most commonly ordered by all users of the system of the present invention. The most commonly ordered products can be viewed in their entirety by displaying and selecting from the entire requisition order or by category. Preferably, a user also may view products that are most commonly ordered by the user itself, with the products being organized in categories customized in accordance with the user's preferences.

In the preferred embodiment, the user selects desired products by entering the quantity of the product required in an input field. The user can select products in any category, switching from one category to another if desired. This enables the user to simply scroll through a list of common item categories and fill in the quantities next to the products the user wishes to order, without having to constantly search for a specific product and then wait for the search results. Within each category, the desired quantity is preferably immediately captured by the system without having to press an “accept” button or the like. The system and method of ordering using the present invention saves the user time because the user can browse through products commonly ordered (preferably by the user itself) and preferably organized by customized categories, and because only one submission is necessary to capture all of the products selected by the user.

Once all the selections are made, the user chooses to place all of the selected items either on a final order form or on a shopping cart. The choice is made by activating an appropriate graphic user interface (GUI) button or by any other means known in the art. If the user chooses to review the items in a shopping cart prior to proceeding to the final order form, he or she can do so, editing or deleting the entries as necessary.

After the user approves each final order form, the system described herein tracks the amount spent by the user and awards free product points based on this amount. The user accumulates more product points with each successive transaction and can redeem the product points immediately or at a later point in time for specific products from the vendor's merchandise. The free product points can be redeemed all at once or partially through successive transactions.

The system described herein also tracks all of the approved final order forms placed by a user. This enables the user to place a new order for merchandise by recreating a past order. To do this, the user reviews his or her past order history and selects the particular past orders to be re-created. The user can re-create any part or all of the selected past orders. The selected orders are placed in a shopping cart to be further reviewed and/or edited by the user. Once the user is satisfied with the recreated and/or edited order, the user proceeds to the final order form to approve the order.

The embodiments of the present invention are described in more detail hereinbelow.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of an embodiment of the ordering system of the present invention;

FIG. 2 is a diagram of a database structure behind an embodiment of the ordering system;

FIG. 3A shows an implementation of an embodiment of the ordering system accessed through the Internet;

FIG. 3B shows an implementation of embodiment of the ordering system accessed through a storage device;

FIG. 4A is a flowchart of initiating order placement using an embodiment of the ordering system;

FIG. 4B is a flowchart of placing an order using an embodiment of the ordering system;

FIG. 4C is a flowchart of placing an order using another embodiment of the ordering system;

FIG. 4D is a flowchart of completing an order and updating order and award points information using an embodiment of the ordering system;

FIG. 4E is a flowchart of reviewing and editing product information using an embodiment of the ordering system;

FIG. 4F is a flowchart of placing an order using a further embodiment of the ordering system;

FIG. 5A is an embodiment of a Reqpad menu screen display in accordance with the present invention;

FIG. 5B is an embodiment of a Reqpad screen display in accordance with the present invention;

FIG. 6 is an embodiment of a Purchase Order screen display in accordance with the present invention;

FIG. 7 is an embodiment of a Cart screen display in accordance with the present invention; and

FIG. 8 is an embodiment of a Re-Create Order screen display in accordance with the present invention.

### DETAILED DESCRIPTION OF PREFERRED EMBODIMENTS

The ordering systems described herein are directed to managing an inventory of office and computer supplies. However, it will be apparent to one skilled in the art that these systems can be applicable to any electronic purchasing-vending relationship.

System Configuration

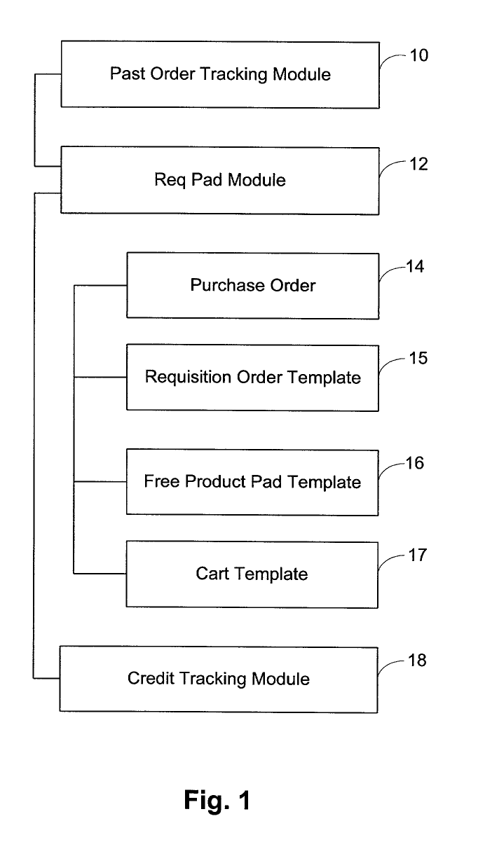

FIG. 1 shows a preferred embodiment of an ordering system, referred to herein inclusively as the System. The System includes a Past Order Tracking Module 10, a Purchase Order Module 14, a Requisition Pad template, referred to herein as Reqpad 12, a Purchase Order template 15, a Free Product Pad template 16, a Cart 17 template and a Credit Tracking Module 18. The role of each of these components is further described below.

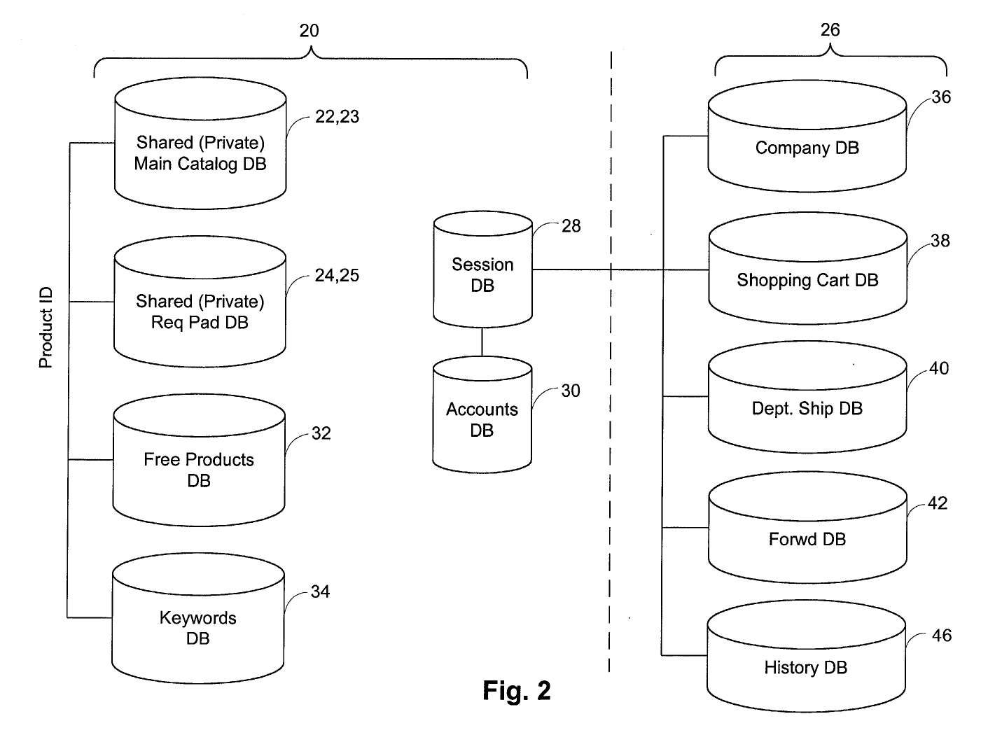

FIG. 2 illustrates the database structure behind the System. Databases 20 are, generally speaking, global databases that are shared by, or whose records are freely accessible by, all users of the System. The global databases include a Shared Main Catalog Database 22, a Shared Reqpad database 24, a Sessions Database 28, an Accounts Database 30, a Free Products database 32, and a Keywords Database 34.

The Shared Main Catalog Database 22 contains information, including pricing, regarding the complete list of products sold by a vendor through the System. If desired, a Private Main Catalog Database 23 may be created for certain users with special discounts or other distinguishing considerations and may contain a customized list of products, prices and any other desired product information. The Private Main Catalog Database 23 is visible only to the specific user. In practice, the Private Main Catalog Database may be constructed from the Shared Main Catalog Database 22, e.g., by allowing access to certain fields or records based on user identification, or a completely separate database may be constructed.

The Shared Reqpad Database 24 contains information regarding products most commonly ordered by all users of the system. The information preferably includes product categories for the most commonly ordered products, product item number, product description, product measurements, price and any other relevant information, including product image if available. The Shared Reqpad Database 24 is preferably relationally linked or indexed to the Shared Main Catalog Database 22 by item number, such as, for example, a prefix number or an item stock number. Preferably, a Private Reqpad Database 25 is created so as to contain customized information regarding products most commonly ordered by a specific user (or account) of the System, including custom pricing and categories. The Private Reqpad Database 25 is visible only to the specific user or account. In practice, Private Reqpad Database 25 may be constructed from the Shared Reqpad Database 24, e.g., by allowing access to certain fields or records based on user identification, or a completely separate database may be used.

The Sessions Database 28 contains a unique record for each user in which the user's logon ID and password, as well as the current status of that user, e.g., valid, expired, guest visitor, and the like, are stored. The System also keeps tracks of each user's “session” and assigns or associates an identification code to each such session. Each unique record in the Session Database 28 stores the corresponding user's last session identification and whether the pending session is still valid. The unique user record also stores the number of free product credits accumulated by the user, last open order, and any other user-related information that a vendor would like to keep track of.

The Accounts Database 30 contains information specific to a user's account, such as, for example, any specific discounts or credits or any other account-related information. The Accounts Database 30 also contains paths that indicate file names or URL locations of each user's private databases such as, for example, a Shopping Cart Database 38 (discussed below), the Private Reqpad Database 25, the Private Main Catalog Database 23, and any other databases specific to a given user.

The Free Products Database 32 contains or points to a list of currently available products that a user can choose from to redeem accumulated free product credits. The Keywords Database 34 contains a list of search keywords to enable a user to search for a particular product if necessary. Preferably, the keywords are customized for each user or account, facilitating a user's familiarity with and ability to choose the right keywords to search for products.

Whereas the Main Catalog Databases and the Reqpad Databases can be shared or private, depending on the arrangement between the user and the vendor, certain databases of the System are private for each account (or particular records thereof are only accessible by users associated with a particular account) and are referred to herein as Private Databases 26. Referring to FIG. 2, the Private Databases 26 include a Company Database 36 which contains users' billing addresses; Shopping Cart Database 38 which contains “shopping cart” data for each user, as explained in greater detail below, such that, preferably, each user has its own shopping cart file; DeptShip Database 40, which contains information regarding department shipping locations (if the user is a company) and alternate billing addresses for each user account; Forwd Database 42, containing information regarding orders currently pending approval for each account; and History Database 46, containing private history information for each account, including past order history. Each Private Database 26 is preferably relationally linked or indexed to the Session Database via the account identification.

The System an be accessed remotely through a network connection or locally through a storage device such as a CD ROM disk installed on the user's computer or server, a magnetic medium or an EIP disk.

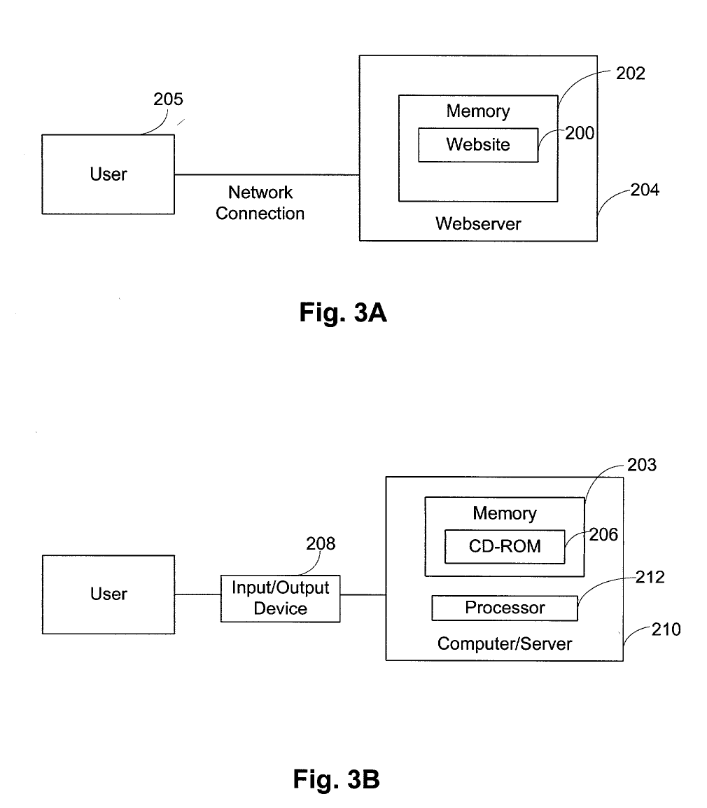

FIG. 3A shows one implementation of the System where it is accessed through the Internet. A user connects to a website 200 via a network connection. The website 200 resides in a memory 202 (comprising volatile and non-volatile memory), where the System databases are located. The web application for the website 200 is run by a webserver 204. In a preferred implementation, the databases in the memory 202 are created in xBase iii format and the code for the client-side device or browser 205 is generated using a combination of Miva Script, HTML and JavaScript. Those skilled in the art will recognize that any suitable database product can be used. In this implementation the System can be used to generate a “remote” purchase order, the data of which resides on the server and can be immediately processed by the vendor.

FIG. 3B shows another implementation of the System where it is accessed from a storage device, such as a CD-ROM 206. In this case, a user accesses the system through an input/output device 208, such as a graphic user interface (GUI), connected to the user's computer or server 210, which comprises a processor 212 to run the CD ROM 206. The databases on the CD-ROM 206 are preferably loaded into a memory 203, for example, by transfer from the CD-ROM 206 during installation. The CD-ROM 206 may be removably incorporated in the memory 203, for example, via a CD ROM drive or changer. In a preferred implementation, the databases in memory 202 are created in Visual Basic and MS Access, although those skilled in the art will recognize that any suitable database product can be used. In this implementation the System can be used to generate a “local” purchase order on the computer which can then be communicated as known in the art to the vendor over a communications network, or generate a paper copy of the purchase order which can be transmitted to the vendor via post or facsimile.

Placing a Purchase Order Using a Reqpad

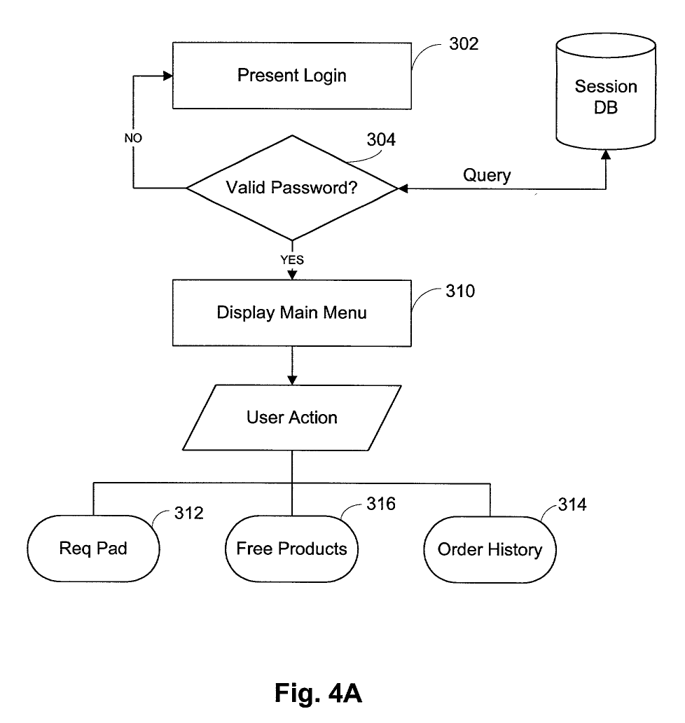

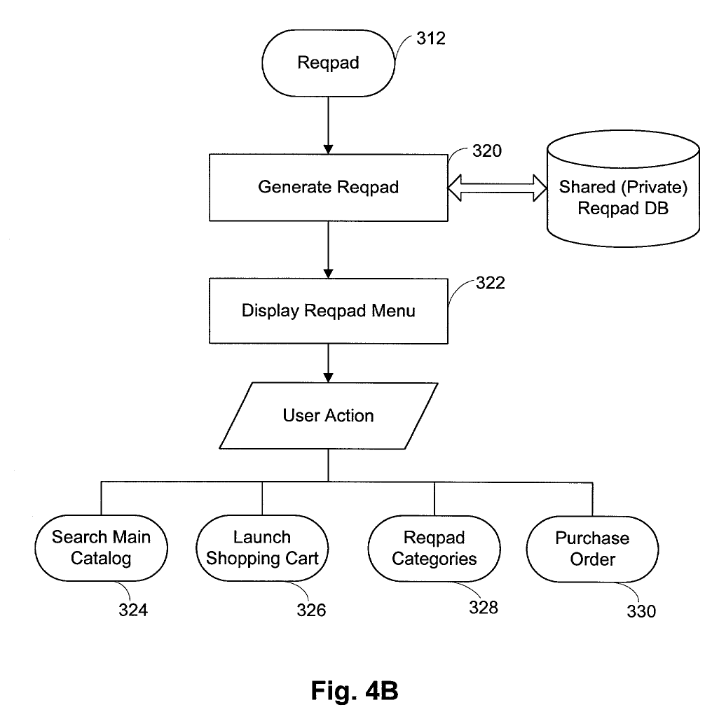

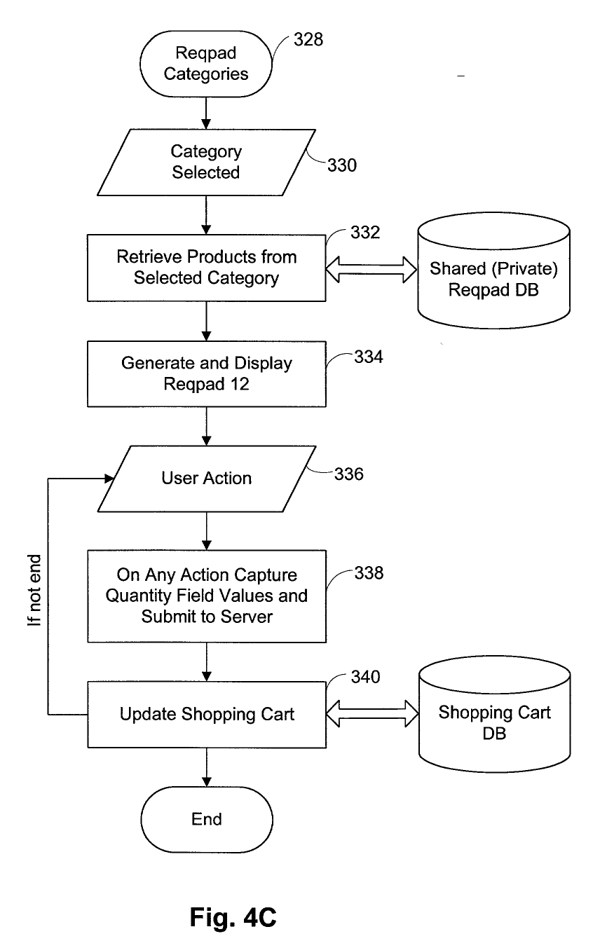

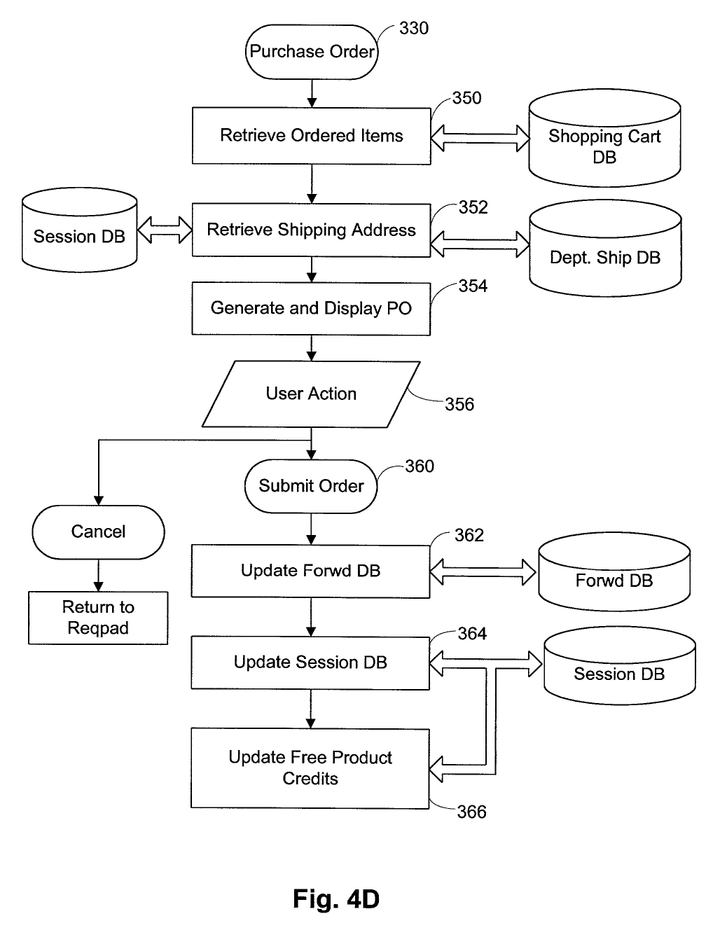

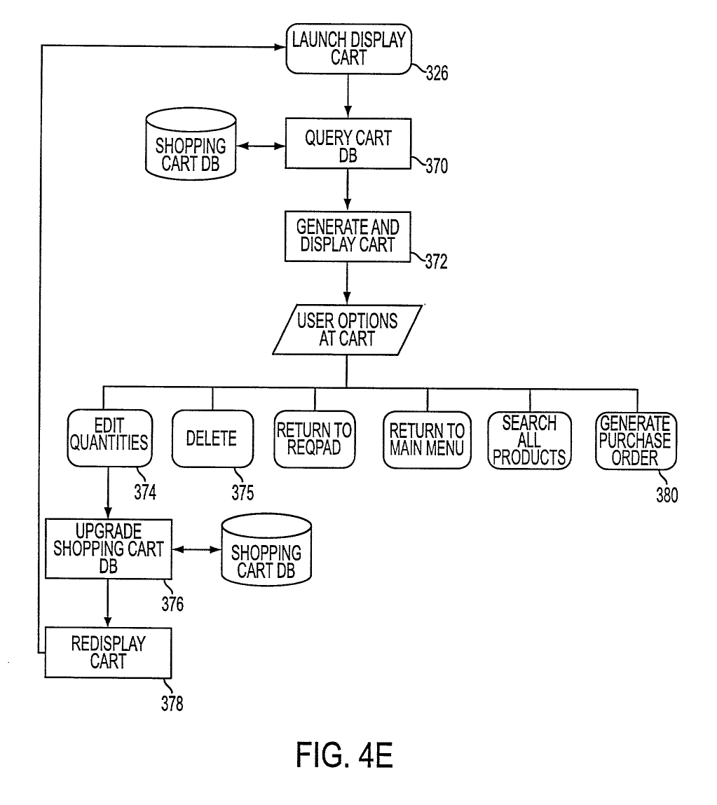

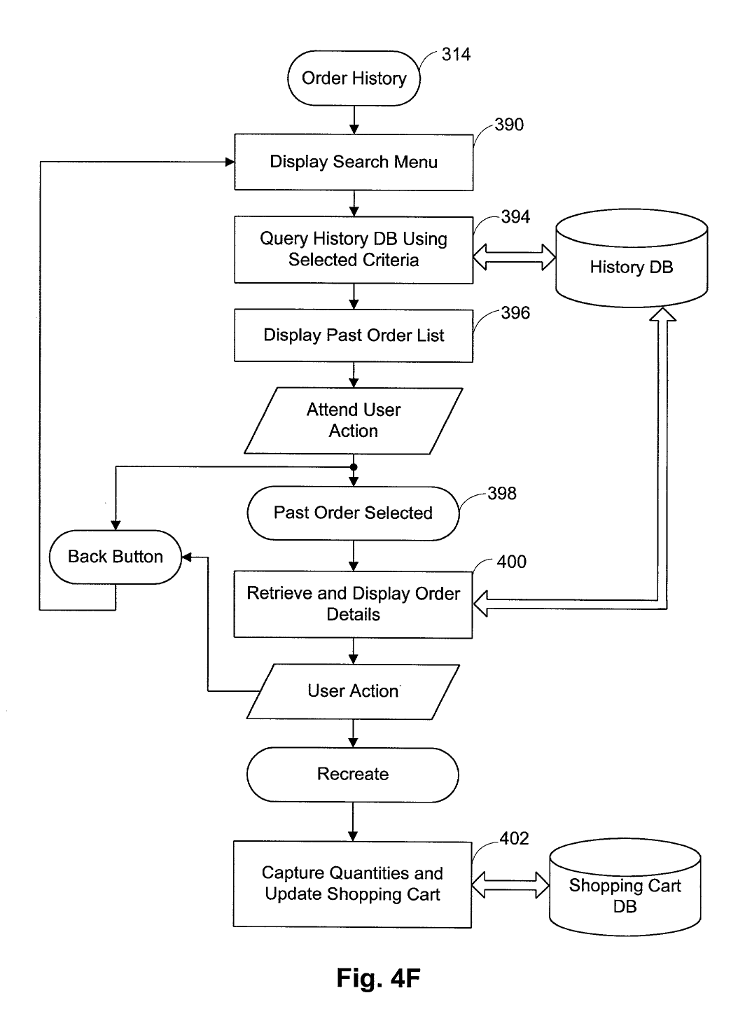

Referring additionally to the flowchart of FIG. 4A, a user accesses the System by providing a member identification and password, step 302, which is verified against the Session Database 28, step 304, or by any other means known in the art. Once a user has accessed the System, it generates a main menu 310 that can contain a variety of options, but for the purposes of describing the System includes at least the following selections:

option 312 for creating or using a Reqpad 12 to purchase products;

option 314 for reviewing past order histories as a basis for purchasing products; and

option 316 for ordering free products.

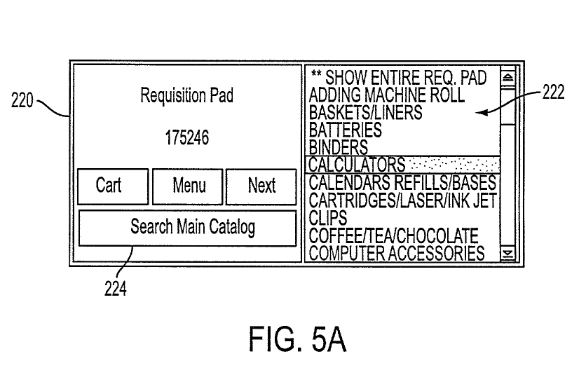

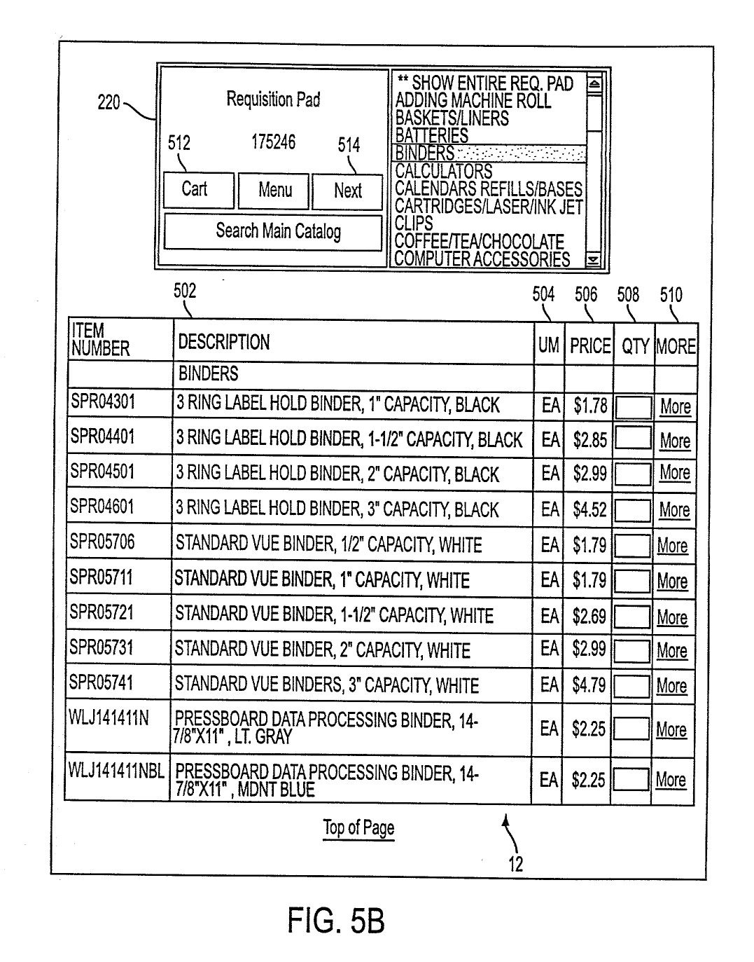

Referring additionally to FIG. 4B, when the user selects the Reqpad option 312 the Purchase Order Module 14 generates and displays a Reqpad menu 220; steps 320, 322. FIG. 5A shows an example of the Reqpad menu 220, which lists or displays various categories of products. Preferably, the list is encapsulated in a scroll box 222. The user may scroll through the categories and choose to view a given category of products stored in the Shared Reqpad Database 22 (or, as the case may be, a Private Reqpad Database 23) or choose to view all products in all categories. The Reqpad menu categories can include, but are not limited to “show all categories,” batteries, binders, calculators, calendars/refills/bases, cartridges/laser/ink jet, clips, computer accessories; correction fluid; desk accessories; diskettes; envelopes & pockets; fans; folders; frames; indexes; labels; notebooks; pads; paper; paper supplies; pens/pencils/markers, POST-IT™ products, punches, ribbons, rolodexes/cards, rubber bands, rulers, shears, sheet protectors, staples/staplers, storage boxes, and tape/tape dispensers. The above categories are listed for illustrational purposes only and it will be understood that a variety of other categories can be included in addition to or instead of the categories listed above.

The Reqpad menu 220 allows a user who has not yet decided upon a specific product to browse through all commonly ordered products in a given category. Additionally and/or alternatively, the user may review all products commonly ordered from a particular vendor. These tasks can be accomplished without having to utilize a search engine and having to continually devise queries, wait for the queries to be processed by the webserver 204 or computer 210 and wait for the responses to come back. The commonly ordered products stored in the Shared Reqpad Database 24 are selected using any number of criteria, such as, for example, a vendor's past experience with client preferences. Alternatively, the ordering system can track all purchases and store the data in a central database. The central database is dynamically updated with each subsequent purchase and a counter is activated and dynamically updated, keeping track of the number of times a given product was ordered and, optionally, the total monetary value expended on a given product over time. Based on the counter and in response to predetermined cut-off criteria, the most commonly ordered products are selected for placement into the Shared Reqpad Database 24. In addition to the criteria described above, the Private Reqpad Database 25 further can be customized based on customer preference; for example, a user may specify which categories, products and quantities of each product are most commonly ordered from the user's account. This information will be stored in the private Reqpad Database 25 and the Reqpad 12 for the customized account will be populated accordingly. Other criteria for selecting the most commonly ordered products for both shared and private accounts will be apparent to one skilled in the art.

FIG. 5B shows an example screen display of a Reqpad 12 actuated from the Reqpad menu 220. More specifically, referring additionally to the flowchart of FIG. 4C, once the user actuates a category from the Reqpad menu 220, step 330, the selected category is used to query the Shared Reqpad Database 24, step 332. Based on the results of the query the System generates and displays a Reqpad 12 populated with information about the most commonly ordered products in the selected category, step 334. Some users may have a special account with the vendor, such as discounts based on bulk orders, custom pricing on a product-by-product bases or other price and product variances. For a user with a special account, the Reqpad 12 is populated with data from a Private Reqpad Database 23 and the System displays information for products most commonly ordered by that user (or account) as well as any applicable custom products and custom product categories. Unlike other ordering systems that require the user to do extensive searches to find the desired products, the user of the Reqpad 12 has ready access to the products that are most commonly ordered by all users of the system or by that particular user of the System. Preferably, the products are listed in alphabetical order although the products also can be listed in the order of increasing or decreasing price.

As shown in FIG. 5B, the Reqpad 12 preferably comprises the following fields:

Item Number 500;

Description 502;

Unit of Measure (UM) 504, such as a case, a box, a package, a carton, etc.;

Price 506;

a Quantity (QTY) 508 input field or box; and

More 510, which provides icons and/or links or hyperlinks to other webpages or data, such as the suggested retail price as compared to the system's product list price, a picture of the product, if a picture is available, and any other useful information.

A variety of other fields can be used in addition to or instead of the fields discussed above in order to carry out the purpose of the ordering program and system described herein.

The user can select any desired product in any category by entering the amount of each product that he or she desires to purchase or contemplates purchasing in the Quantity input field or box 508, step 336. For example, the user can select one or more products in the “Binders” category by entering the desired quantity of each product in the corresponding Quantity input fields or boxes 508, then switch to the “Clips” category and select one or more products there by inputting the desired quantity and then switch to the “Computer Accessories” category and so on until the user has selected all desired products in all categories of interest to the user. Each time the user enters a number or value in a Quantity input field or boxes 508, the server captures the quantity, step 338 and updates the Shopping Cart Database 38, step 340. In this manner, the System eliminates the use of an “enter” button or similar mechanism, and in fact it should be noticed from FIG. 5B that the Reqpad 12 does not have such a button on it. Similarly, each time a user changes the number value in a Quantity input field or boxes 508, the server captures the new quantity and updates the Shopping Cart Database 38. Finally, each time a user changes the number value in a Quantity input field or boxes 508 to zero (0), the server captures the new quantity and updates the Shopping Cart Database 38 to remove the nulled product from the user's selections. The automated quantity capture is preferably implemented using a server-side script or program, e.g., a Miva Script, which controls the input field or boxes 508.

If a user wishes to purchase a product that is not listed on the Reqpad 12, the Reqpad menu 220 preferably offers the user access to a search engine for searching the Shared Main Catalog Database 22 or, as the case may be, the Private Main Catalog Database 23. The user then selects the desired products by inputting the quantity as described above.

Once the selection process is complete, the user has a choice to complete the purchase order or first to review and, if necessary, edit the order. Referring to FIG. 5B, if the user chooses to complete the purchase order, he or she clicks or otherwise activates a “next” button 514 or other graphic user interface (GUI) element. Referring additionally to the flowchart of FIG. 4D, the Purchase Order Module 14 then generates a purchase order form, referred to herein as a Purchase Order template 15, based on the data previously captured from the user and stored in the Shopping Cart Database 38, step 350. The Purchase Order Module preferably also obtains shipping and account information, step 352, and any other desired information which the merchant wishes to display, step 354, on the purchase order. This enables a user to select as many products in as many categories as the user may desire and then perform only a single action to place all of the desired products on the Purchase Order template 15.

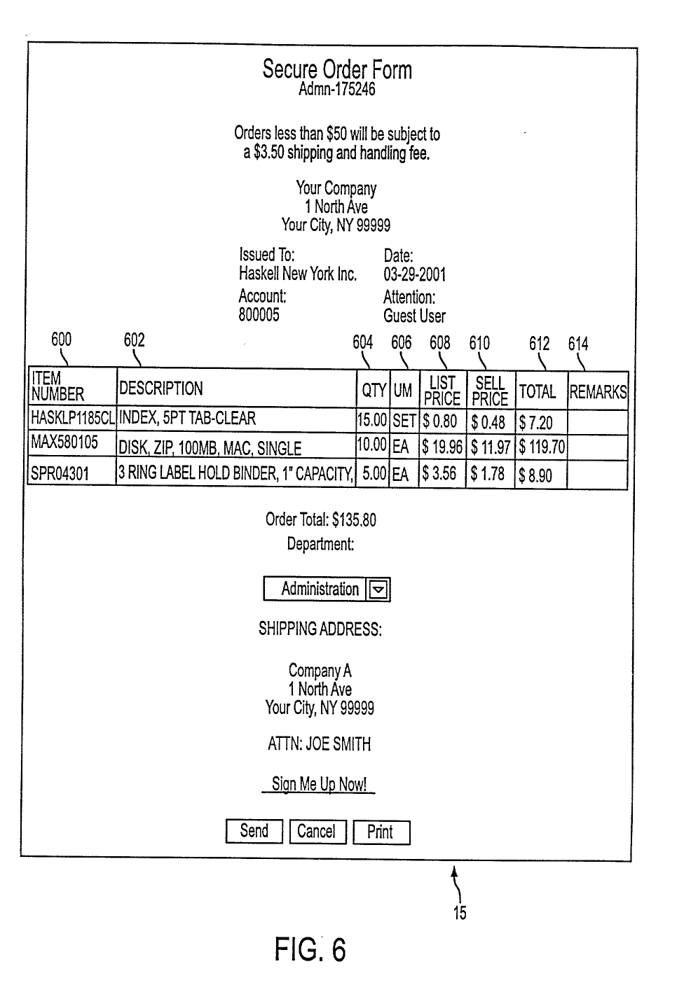

FIG. 6 shows an example screen display of the Purchase Order template 15. The illustrated Purchase Order template 15 includes the following fields for each product entry:

Item Number 600;

Product Description 602;

Quantity (QTY) 604;

Unit of Measure (UM) 606;

List Price 608 for one product;

Sell Price 610 for one product;

Total 612, indicating the total price for the selected quantity of each product; and

Remarks 614, which can include a special notice regarding a product or its delivery information, where appropriate.

It will be understood that the Purchase Order template 15 shown in FIG. 6 is used for illustration purposes only and that many other representations are possible.

After viewing the Requisition Order 15, the user can print and approve or cancel the order by use of known GUI icons and functions. When the order is submitted, step 360, the Forwd Database 42, the Session Database 28, Account Database 30 and History Database 46 are updated, steps 362, 364, 366, and 368.

Referring back to FIG. 5B, the user need not go directly to the Purchase Order template 15 after completing the Reqpad 12 selection process. Instead, the user first can choose to review and, if necessary, edit the selected products and quantities. To do this, the user clicks or otherwise activates a “cart” button 512 or similar GUI. Referring additionally to the flowchart of FIG. 4E, the Purchase Order Module 14 then generates a virtual shopping cart, also referred to herein as a Cart template 17, based on the data previously captured from the user and stored in the Shopping Cart Database 38, steps 370 and 372. Again, a user can select as many products in as many categories as the user may desire and then perform only a single action to place all of the desired products on the Cart 17.

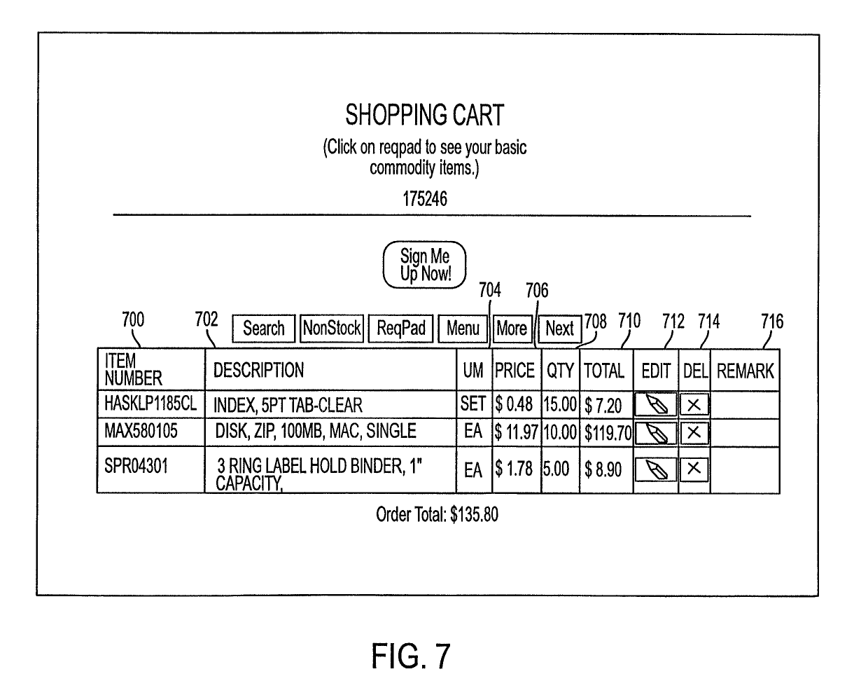

Referring to FIG. 7, an embodiment of the Cart 17 can include the following fields for each product entry:

Item Number 700;

product description 702;

Unit of Measure (UM) 704, such as a case, a box, a package, a carton, etc;

Price 706 per product;

Quantity (Qty) 708;

Total Price 710, indicating the total price for the selected quantity of each product;

Edit 712;

Delete (Del) 714; and

Remarks 716, which can include a special notice regarding a product or its delivery information, where appropriate.

The Edit 712 and Delete 714 fields are associated with GUI buttons allowing a user to interact with the program. If the user activates the Edit 712 GUI button, the System allows the user to change the selected quantity of the entry being edited and to enter any remarks, steps 374, 376 and 378. If the user activates the Delete 714 GUI button, the System deletes the selected entry, step 375.

If, after reviewing and, if necessary, editing the information displayed in the Cart 17, the user would like to purchase the displayed items, the user activates the “send” GUI button and the Purchase Order Module 14 generates the Purchase Order 15 and transfers all of the user entries thereto, step 380. The user can then print and accept or cancel the order as described above.

Alternatively, from Cart 17, the System allows a user to return to the main menu or to Reqpad 12, or to search the system for other products of interest, among many other options. Until the final purchase is approved, the System provides the user with options to return to the main menu, search the Reqpad 12 or the entire system and order nonstock products as well as any other desired options.

Free Product Credits

Each time a user approves a Purchase Order 15, the Purchase Order Module 14 transfers the order data to the Credit Tracking Module 18, which generates a specific amount of free product credits that are stored in the Accounts Database 30. The number of credits earned towards free products can, for example, be based on the total dollar value of the purchase order. The free product credits can be redeemed for selected items of the vendor's merchandise, which are stored in the Free Products Database 32. The credits can, but do not need to be, redeemed at the time of placing the order entitling the user to such credits. The Credit Tracking Module 18 accumulates the free product credits, up to a predefined maximum amount allowed by the System, deducts the amount of free-product credits redeemed in exchange for products, and adjusts the available credit balance accordingly. A user can, but does not have to redeem all of the accumulated free product credits at one time; if the user redeems only some of the credits, the Credit Tracking Module 18 adjusts the available credit balance accordingly, and the user can redeem some or all of the remaining credits at a subsequent time.

If desired for practical purposes, the system Credit Tracking Module 18 can be programmed to cause the expiration of all credits remaining unredeemed after a given time limit, such as months or years. Accumulating free product credits for use at a later time allows users that place multiple but small dollar value orders to make the best use of their credits.

When a user is ready to redeem some or all of the free-product credits, the Credit Tracking Module 18 generates a page referred to herein as a Free Product Pad 16. The Free Product Pad 16 is populated with data from the Accounts Database 30 and the Free Products Database 32. The Free Product Pad 16 displays the total amount of credits available to the user. Preferably the total amount of available credits is represented as a dollar amount. Preferably, the Free Product Pad 16 also displays a free product list which is similar to the list of Reqpad 12, except that the products are listed in the order or increasing dollar value rather than alphabetically. The user can scroll through the list to determine the value of and further information about each product on the list and can follow links leading to yet further information and, if available, pictures of each product. The user can select to purchase a product or products in exchange for all or a part of the accumulated free product credits. The selection and purchasing process for the free products are preferably similar to the selection and purchasing processes described above in connection with placing a purchase order.

For example, the Free Product Pad 16, can include the following fields: Item Number; Description; Unit of Measure (UM), such as a case, a box, a package, a carton, etc.; Credits, representing the dollar value of the product; and More. Clicking on the More field will link the user to a further description and picture of the product. The user can select to order a given quantity of each free product, as long as the cost of the order does not exceed the amount of accumulated credits.

In order to maximize the user's options, the Free Products Database 32 also can be searched by means of a search engine, a browser or any other means known in the art.

Thus, the System enables the user to quickly and conveniently order products while at the same time accumulating free product credits redeemable either at the time of purchase or at a later point in time, for the same merchandize that the user is willing to spend money to buy in the first place.

Placing a Purchase Order by Recreating a Past Order

The information from each order processed by the Purchase Order Module 14 is transferred to the Past Order Tracking Module 10 which stores the data in the History Database 46. A user can choose to recreate a portion or all of a previously placed order, and if so, the user selects from the main menu the option 314 to review past order histories. Referring additionally to the flowchart of FIG. 4F, the System allows a user to review and browse through all of the user's past orders or to perform a search for specific past orders, step 390. If the user chooses to perform a search, it can be performed by one or more filters, such as, for example, by purchase order number, department, item number, manufacturer, product description, and any other filter programmed into the System for the convenience of the user.

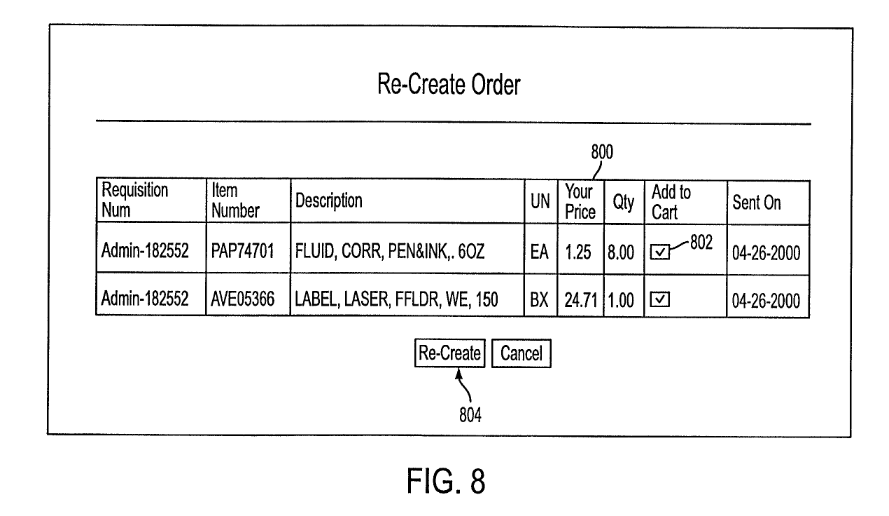

Once the search is performed, step 394, the Purchase Order Module 14 displays a list of all previous purchase orders stored in the History Database 46 which match the search criteria, step 396. The user can select one of these, step 398, in which case the Purchase Order Module 14 generates a historical order form, step 400, based on information retrieved from the History Database 46. An example historical order form 800 is shown in FIG. 8. The form 800 enables the user to select any or all previously ordered products, as provided by an Add to Cart checkbox 802. If the user activates the “Re-Create” GUI button 804, the Purchase Order Module 14 captures the selected products and adds the data to the Cart 17, step 402. The user can then review and edit the information as necessary, as described above. If the user is satisfied with the re-created and/or edited order, the user can proceed to the Purchase Order Pad 15 as described above and complete the purchase in the usual manner.

In one embodiment of the invention, the user can recreate a past order for the purpose of returning products listed in that order. To do so, preferably the user enters a preassigned Return Materials Authorization Number, confirming that the user is authorized to return the goods. The return order is then submitted in the same way that a new order is submitted.

Those skilled in the art will understand that numerous variations and modifications may be made to the specific embodiments described herein without departing from the spirit and scope of the invention.

1. A method of ordering products from an electronic database using a computer system, said method comprising:
categorizing the products represented in said electronic database into pre-defined categories;
maintaining a list of commonly purchased products in each said category;
displaying at least a partial listing of said categories;
enabling a user to select at least one displayed category; and
displaying an electronic order form comprising at least a portion of the commonly purchased products corresponding to said selected category.

2. The method of claim 1, wherein each said list of commonly purchased products is based on a history of prior orders, said history being dynamically updated over time.

3. The method of claim 1, wherein said pre-defined categories are customized for a specific user.

4. The method of claim 1, wherein said list of commonly purchased products is customized to display products most commonly ordered by a specific user.

5. The method of claim 1, including:
providing multiple of said lists of commonly purchased products, wherein each said product list comprises at least a product name and an input field for enabling a user to indicate a desired quantity of said product to be purchased; and
for each said product list, automatically capturing all products and quantities desired by the user to an aggregate product list prior to displaying another said product list.

6. The method of claim 5, further including, for each said product list:
enabling a user to change to zero or to delete said quantity of said product to be purchased; and
automatically capturing all changes to said quantity of said product to an aggregate product list and removing said product from said aggregate product list prior to displaying another said product list.

7. The method of claim 5, wherein said aggregate product list is an editable shopping cart form.

8. The method of claim 5, wherein said aggregate product list is a final purchase order.

9. The method of claim 1, wherein said computer system is a client-server based system, said electronic database is stored on the server, and said product list is displayable on said client.

10. The method according to claim 1, wherein said computer system is personal computer system, and said electronic database is stored on the computer system.

11. A method for ordering products from an electronic database, said method comprising:
storing electronic purchase orders created by a user on a computer system;
enabling said user to search for and select previous purchase orders;
enabling a user to select a previously ordered product from said previous purchase order for automatic inclusion in a current purchase order.

12. The method of claim 11, further comprising enabling said user to modify information regarding said selected previously ordered product, including at least the quantity of product.

13. The method of claim 11, further comprising enabling said user to search for said previous purchase orders using a search criteria or to view all previous purchase orders.

14. The method of claim 13, wherein the search criteria includes at least one of purchase order number, product number and product description.

15. The method of claim 11, wherein said computer system is a client-server based system, said electronic database is stored on the server, and said product list is displayable on said client.

16. The method according to claim 11, wherein said computer system is a personal computer system, and said electronic database is stored on the computer system.

17. A method for ordering product electronically, said method comprising:
provisioning multiple product lists available for display, each said product list having at least a product name and an input field for enabling a user to indicate a desired quantity of said product to be purchased; and
for each said product list, automatically capturing all products and quantities desired for purchase by the user to an aggregate product list prior to displaying another said product list.

18. The method of claim 17, wherein said aggregate product list is a final purchase order which said user accepts or denies.

19. The method of claim 18, further comprising enabling said user to review and modify said aggregate product list and automatically transmitting all products and quantities from said aggregated product list to a final purchase order which said user accepts or denies.

10. The method of claim 17, wherein said computer system is a client-server based system, said electronic database is stored on the server, and said product list is displayable on said client.

21. The method according to claim 17, wherein said computer system is personal computer system, and said electronic database is stored on the computer system.

22. A method for awarding credits redeemable for products, said method comprising:
enabling a user to electronically place a purchase order from a vender;
tracking a monetary value of said purchase order and converting said monetary value into earned credits which a user can redeem for products from the vender during one or more subsequent ordering sessions;
maintaining a list of products which can be acquired with said earned credits, said list having at least a product name and a product value expressed in credits;
making said list available for searching during the subsequent ordering session; and
enabling said user to search for and select said products in exchange for said earned credits.

23. The method of claim 22, wherein said earned credits are displayed as a dollar value.

24. The method of claim 22, further comprising enabling said user to redeem said earned credits during one or more ordering sessions, tracking credits earned and credits redeemed throughout multiple ordering sessions and adjusting remaining earned credit balance.

25. The method of claim 22, further comprising setting a predetermined maximum amount of said earned credits which said user can accumulate.

26. The method of claim 22, further comprising setting a predetermined maximum amount of time after which unredeemed earned credits expire.

27. A method of ordering products from an electronic database using a computer system, said method comprising:
categorizing the products represented in said electronic database into pre-defined categories that are customized for a specific user;
maintaining a list of commonly purchased products in each said category, said list comprising at least a product name and a price, wherein said list is customized to display products most commonly ordered by said specific user and custom prices payable by said specific user;
displaying at least a partial listing of said categories;
enabling a user to select at least one displayed category;
displaying an electronic order form comprising at least a portion of the commonly purchased products corresponding to said selected category;
providing multiple of said lists of commonly purchased products, wherein each said product list further comprises an input field for enabling a user to indicate a desired quantity of said product to be purchased; and
for each said product list, automatically capturing all products and quantities desired by the user to an aggregate product list prior to displaying another said product list;
enabling a user to change to zero or to delete said quantity of said product to be purchased; and
automatically capturing all changes to said quantity of said product to an aggregate product list and removing said product from said aggregate product list prior to displaying another said product list.
